(19) United States
(12) Patent Application Publication
(10) Pub. No.: US 2026/0138852 A1
(43) Pub. Date: May 21, 2026

(54) ELEVATOR ELEMENT AND ELEVATOR

(71) Applicant: Kone Corporation, Helsinki (FI)

(72) Inventors: Petri KOLI, Helsinki (FI); Tapani TALONEN, Helsinki (FI)

(73) Assignee: Kone Corporation, Helsinki (FI)

(21) Appl. No.: 19/443,745

(22) Filed: Jan. 8, 2026

Related U.S. Application Data
(63) Continuation of application No. PCT/EP2023/073367, filed on Aug. 25, 2023.

(51) Int. Cl. B66B 17/12

(52) U.S. Cl. CPC B66B 17/12

(57) ABSTRACT

An elevator element and an elevator. The elevator element comprises a body part made of CO₂-cured slag, and a reinforcing element embedded in the body part. The reinforcing element is made of fibre-reinforced plastic (FRP).

### CROSS-REFERENCE TO RELATED APPLICATION

This application is a continuation of PCT International Application No. PCT/EP2023/073367 which has an International filing date of Aug. 25, 2023, the entire contents of which are incorporated herein by reference.

### BACKGROUND

The invention relates to an elevator element, such as a counterweight or a balance weight.

The invention further relates to an elevator comprising the elevator element.

A challenge with manufacturing of elevators is that environmental load thereof shall be cut down.

### BRIEF DESCRIPTION

Viewed from a first aspect, there can be provided an elevator element, comprising a body part made of CO₂-cured slag, and a reinforcing element embedded in the body part, wherein the reinforcing element is made of Fibre-reinforced plastic (FRP).

Thereby an elevator element having reduced environmental load and solid and safe structure may be achieved. Also an advantage is that the reinforcing element made of FRP plastic stands well chemical attacks caused by the nature of CO₂-cured slag, and therefore the reinforcing element will not corrode but maintains its strength, extending thus the operating life of the elevator element.

Viewed from a further aspect, there can be provided an elevator comprising the elevator element according to the first aspect.

Thereby an elevator having long operating life on all its elements and reduced environmental load may be achieved.

The arrangement and the method are characterised by what is stated in the independent claims. Some other embodiments are characterised by what is stated in the other claims. Inventive embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit sub-tasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

Various embodiments of the first aspect may comprise at least one feature from the following paragraphs:

In one embodiment, the reinforcing element comprises glass-fibres embedded in polymer matrix.

An advantage is that an inexpensive and easily shaped elevator element may be achieved.

In one embodiment, the reinforcing element comprises basalt-fibres embedded in polymer matrix.

An advantage is that a reinforcing element that a reinforcing element that is highly resistant to acidic and salt attack and alkaline may be achieved.

In one embodiment, a frame structure is arranged on the surface of the body part, and wherein the reinforcing element is arranged to overlap with the frame structure.

An advantage is that the frame structure and the reinforcing element constitute a continuous and solid reinforcement structure that may improve the safety of the elevator.

In one embodiment, the element is a counterweight.

An advantage is that a robust and safe counterweight causing very low environmental load may be achieved.

In one embodiment, the element is a balance weight.

An advantage is that a robust and safe balance weight causing very low environmental load may be achieved.

### BRIEF DESCRIPTION OF FIGURES

Some embodiments illustrating the present disclosure are described in more detail in the attached drawings, in which

FIG. 1a is a schematic view of an elevator element,

FIG. 1b is a schematic side view of the elevator element shown in FIG. 1a in partial cross-section,

FIG. 2 is a schematic side view of another elevator element shown in partial cross-section,

FIG. 3 is a schematic side view of third elevator element shown in partial cross-section,

FIGS. 4a-4c are schematic views of some embodiments of a reinforcing element, and

FIG. 5 is a schematic side view of an elevator comprising elevator elements shown in partial cross-section.

In the figures, some embodiments are shown simplified for the sake of clarity. Similar parts are marked with the same reference numbers in the figures.

### DETAILED DESCRIPTION

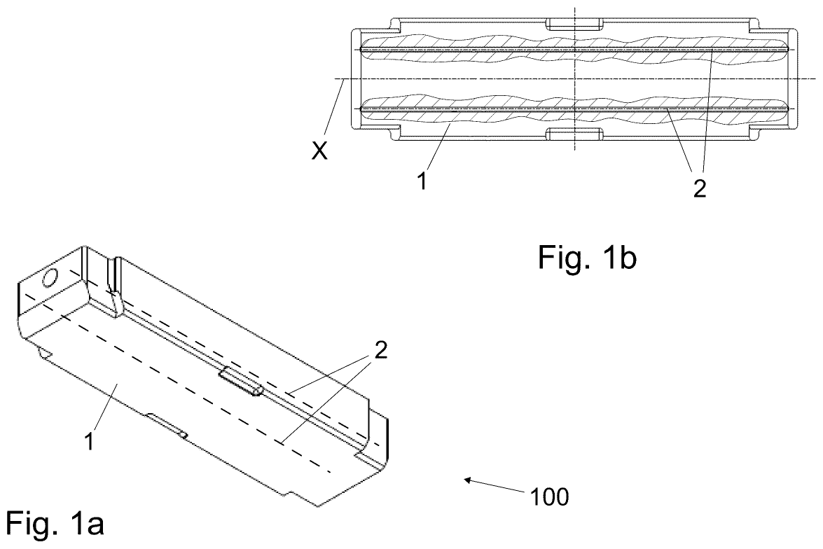

FIG. 1a is a schematic view of an elevator element, and FIG. 1b is a schematic side view of the elevator element shown in FIG. 1a in partial cross-section.

The elevator element 100 comprises a body part 1 that is made of CO₂-cured slag, and at least one reinforcing element 2 embedded at least partly in the body part 1. The reinforcing element 2 is made of fibre-reinforced plastic (FRP). The elevator element 100 comprises two reinforcing elements 2 that have a shape of straight bar.

In one embodiment, the element 100 is a counterweight intended for use in an elevator.

In one embodiment, the element 100 is a balance weight intended for use in an elevator.

The CO₂-cured slag may be manufactured from materials comprising silicate comprising second divalent metal. The material may comprise e.g. ash, fly ash, slag, a silicate comprising mineral, tailings, a side stream material from industrial process, and any mixtures and combinations thereof. The ash may be ash obtainable from the combustion or incineration of coal, biomass and/or waste. The fly ash may be obtainable from the combustion of coal, biomass, oil and/or waste. The slag may be slag obtainable as a by-product of iron or steel-making.

In one embodiment, the slag comprises blast furnace slag (BF slag). BF slag is a non-metallic coproduct produced in a blast furnace in the production of iron. Typically, BF slag consists primarily of silicates, aluminosilicates, and calcium-alumina-silicates. In one embodiment, the slag comprises basic-oxygen furnace slag (BOF slag). BOF slag is a waste product in a basic-oxygen furnace generated during the steelmaking process. Typically, BOF slag contains SiO₂, CaO, MgO, iron (mixed oxides), Al₂O₃, MnO, and other oxides.

In one embodiment, the slag comprises electric-arc furnace slag (EAF slag). EAF slag is a non-metallic by-product that consists mainly of silicates and oxides formed during the process of refining the molten steel. Typically, the main elements in the EAF slag are iron, calcium, silicon, and aluminium oxides; the minor elements in the EAF slag are magnesium and manganese oxides.

In one embodiment, the slag comprises ladle furnace slag, AOD (Argon Oxygen Decarburization) slag or converter slag. In one embodiment, the slag comes from stainless steel manufacturing process.

In one embodiment, the slag comprises klockner oxygen blown maxhutte slag (KOBM slag).

In one embodiment, the slag comprises casting slag that is a waste product generated during the casting of iron or steel.

In one embodiment, the slag is a mixture comprising at least two slags mentioned in the current disclosure.

In one embodiment, the slag is for the most part a mixture comprising at least one slag mentioned in the current disclosure and a minor part Portland cement.

The material comprises silicate comprising a second divalent metal. In one embodiment, the material comprises at least one second divalent metal selected from Ca, Cu, Fe, Ni, Co, Mn, Mg, Si, Zn, Pd, Cd, Sn, Pt and Pb. In one embodiment, the material comprises at least two second divalent metals. Plurality of second divalent metals may exist in the material by its nature, or they may be added purposely in the material.

The body part 1 may be manufactured by a method where water is added to the material comprising silicate comprising second divalent metal, such as slag, for creating a mixture suitable for preparing a hardenable mixture or mass that is suitable for casting, and a mould is filled with said mixture. The creating of the mixture may comprise a step where the mixture is mixed thoroughly. In other words, the mixture is prepared prior to filling the mould.

In another embodiment of the method, water, or at least part thereof, is provided in the mould, and then the material comprising silicate comprising second divalent metal, such as slag, is added in the mould where is already water. Thus, the mixture is prepared in the mould. The preparing of the mixture in the mould may comprise a step where the mixture is mixed thoroughly.

In still another embodiment, the material comprising silicate comprising second divalent metal, such as slag, or at least part thereof, is provided in the mould, and then water is added in the mould where is already said material. Thus, the mixture is prepared in the mould. The preparing of the mixture in the mould may comprise a step where the mixture is mixed thoroughly.

In one embodiment of the method, CO₂ in gaseous form is added in the mixture arranged in the mould and allowed to react with water and the material. In one embodiment, the mould is an open-type of mould wherein the mixture is not compressed or compacted. In another embodiment, the mould is a compression mould wherein the mixture is compressed and compacted during moulding.

In one embodiment, CO₂ is injected by pressure by at least one injector in the mixture. In one embodiment, the mould and the mixture therein are arranged in a pressure chamber under overpressure, e.g. 1-2 bar overpressure, and CO₂ is allowed to absorb and react in the mixture. As a result, bonding structures based on metal carbonates (MCO₃) are created. In one embodiment, said reaction of water, CO₂ and said slag powder/granulate takes place at a room temperature.

In one embodiment, CO₂ is added to the mixture at atmospheric pressure. Thus, very inexpensive equipment can be used.

As used herein, the term “bonding structure” refers to a chemical unit comprising several atoms bonded together by covalent bonds, ionic bonds, as complexes, crystal structures, or combinations or hybrids thereof. A non-limiting example of bonding structures are tetrahedral arrangements formed by a tetravalent metal covalently bonded to four oxygen atoms. In the aforementioned non-limiting example, several tetrahedral bonding structures may be joined together by covalent bonds to form more complex structures such as double tetrahedrons, triple tetrahedrons, etc. The bonding structure may also incorporate addition ion donators, such as metallic ions, to enable forming the tetrahedral structure with central atoms that are divalent or trivalent.

In one embodiment, a plurality of bonding structures may be connected through a linker to form a polymer. In one embodiment, the linker comprises a divalent metal. In another embodiment, the linker comprises a metal carbonate wherein the metal is a divalent metal. In one embodiment, the polymer may comprise a plurality of metal carbonate moieties between bonding structures.

In one embodiment, the polymer may be branched at the bonding structure by connecting it to a plurality of linkers.

In one embodiment, the at least one divalent metal comprises calcium that reacts with water so that calcium hydroxide is created. Then, calcium hydroxide reacts with carbon dioxide and creates bonding structures based on CaCO₃:

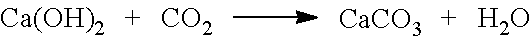

Hardening 305, i.e. reactions creating bonding structures, of the mixture is allowed to proceed in the mould for a desired period of time. Typically, the mixture continues to harden for a long time. However, in one embodiment, the mixture or article moulded in the mould may be removed from the mould such that the hardening of the mixture continues after said removal from the mould. The method according to the current disclosure may provide quick hardening of the mixture to its final strength. For example, it has been observed that in one embodiment the final compression strength may be achieved in about 24 hours, which is ⅓-½ of time required for hardening of Portland cement. Still the compression strength is high, about 40-50 MPa. Even compression strength as high as 80 MPa has been reached in cases where the mixture is devoid of iron Fe.

In at least some cases, the article moulded in the mould needs to be processed further in order to create the desired element or body part 1 thereof. This may comprise e.g. removing and/or adding material, and/or adding components or elements in the article.

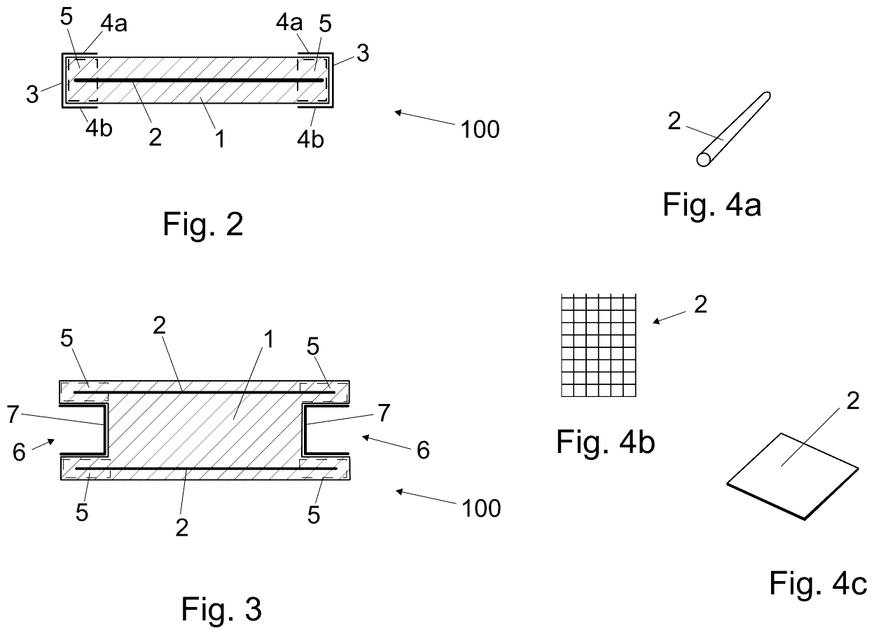

FIG. 2 is a schematic side view of another elevator element shown in partial cross-section.

In one embodiment, the body part 1 is arranged in a frame structure 3. In one embodiment, the frame structure 3 is arranged on the outer surface of the body part 1. The frame structure 3 may be of metal material, such as steel, or of composite material, etc.

In one embodiment, the frame structure 3 is attached to the body part 1 by suitable attaching means or by adhesive. The attaching means may comprise a mechanical locking element that prevents the body part(s) 1 from jumping in quick changes of course, etc. In one embodiment, a shape locking is used between the body part 1 and the frame structure 3 and/or between two or more body parts. Thus, the shape of the frame structure 3 may be designed to fit to the shape of the body part 1 so that a direct attachment therebetween is not needed.

The frame structure 3 may accommodate just one body part 1, but in some embodiments, there are plurality of body parts 1 in one frame structure 3. In other words, the elevator element 100 may comprise just one body part 1 or alternatively multiple body parts 1, for instance two, three or more, even dozens body parts 1 made separately.

In one embodiment, the reinforcing element 2 is arranged to overlap with the frame structure 3. For instance, in the embodiment shown in FIG. 2 the frame structure 3 comprises two parts, each of which comprises two sub-parts 4a, 4b that extend on two opposite surfaces of the body part 1. The reinforcing element 2 is extends in a section of the body part 5 that is situated between said two sub-parts 4a, 4b. Thus, the reinforcing element 2 is overlapping with the two sub-parts 4a, 4b of both parts of the frame structure 3.

In one embodiment, all the reinforcing elements 2 embedded in the body part 1 are overlapping with the frame structure 3. In another embodiment, some but not all the reinforcing elements 2 embedded in the body part 1 are overlapping with the frame structure 3.

FIG. 3 is a schematic side view of third elevator element shown in partial cross-section.

In one embodiment, the surface of the body part 1 comprises at least one recess 6. The embodiment shown in FIG. 3 comprises two basically U-shaped recesses. The frame structure 3 comprises an inward sub-part 7 that is fitted on the surface of the recess 6. The embodiment shown in FIG. 3 comprises two inward sub-parts 7 arranged in said recesses, but it is to be noted that the number of the recesses 6 and the inward sub-parts 7 may vary.

The reinforcing elements 2 are arranged to extend in section of the body part 5 being on situated laterally with the inward sub-part 7. Thus, the reinforcing elements 2 overlap with the frame structure 3. This kind of overlapping of the frame structure and the reinforcing element provides an advantage that if the material of the body part 5 for some reason breaks or cracks, the overlapping structure prevents the part for loosen or come off the elevator element. Thus, the loosen part cannot drop in the pit of the elevator and cause dangerous situation. The material of the body part 5 may break or crack if the counterweight jumps or stops its movement uncontrolled way, for instance. Same advantage applies also in the embodiment shown in FIG. 2.

FIGS. 4a-4c are schematic views of some embodiments of a reinforcing element. As already mentioned, the reinforcing element 2 is made of fibre-reinforced plastic (FRP).

In one embodiment, the reinforcing element 2 comprises glass-fibres embedded in a polymer matrix. Glass-fibres are manufactured from molten glass of silica-based or other formulation glass that is for example drawn or extruded in filaments.

In one embodiment, the reinforcing element 2 comprises carbon-fibres embedded in a polymer matrix. Carbon-fibres are manufactured from e.g. polyacrylonitrile (PAN), rayon, or petroleum pitch. All these polymers are known as a precursor. The precursor is drawn or spun into filament yarns, and then heated to drive off non-carbon atoms, producing the final carbon fiber.

In one embodiment, the reinforcing element 2 comprises aramid-fibres embedded in a polymer matrix. Aramid-fibres are manufactured by spinning a dissolved aromatic polyamide(s) to a solid fiber from a liquid chemical blend.

In one embodiment, the reinforcing element 2 comprises basalt-fibres embedded in a polymer matrix. Basalt-fibres are produced from basalt rocks by melting them and converting the melt into fibres.

In one embodiment, the polymer matrix is selected in epoxy resins, vinyl resins, polyester resins, for instance. The matrix further comprises curing agents, additives and auxiliary substances that helps the manufacturing process, for instance.

In one embodiment, the reinforcing element 2 has a shape of a bar. The bar may be straight, such as shown in FIG. 4a, or it may comprise at least one bend or curve.

In one embodiment, the reinforcing element 2 in shape of a bar has a roundish, such as round cross-section. In other embodiments, the bar may have an angular cross-section.

In one embodiment, the reinforcing element 2 has a shape of rebar. The term “rebar” means in this description a bar that has bulges, stripes recesses and/or grooves on its surface. In one embodiment, one or more stripes is/are spiraling the rod. In another embodiment, the bar is substantially smooth.

In one embodiment, the reinforcing element 2 comprises a web, i.e. a mesh of bars or wires. Said bars or wires are made of fibre-reinforced plastic (FRP) that are reinforced by e.g. glass-fibres, carbon-fibres, aramid-fibres or basalt-fibres.

The web may have a rectangular shape, such as shown in FIG. 4b, but also other shapes are possible. In one embodiment, the web is planar. In another embodiment, the web comprises one or more bends or other forms that provide a three-dimensional character for the web.

In one embodiment, the reinforcing element 2 has a shape of a plate. The plate may be straight, such as shown in FIG. 4a, or it may comprise at least one bend or curve that provides a three-dimensional character for the plate.

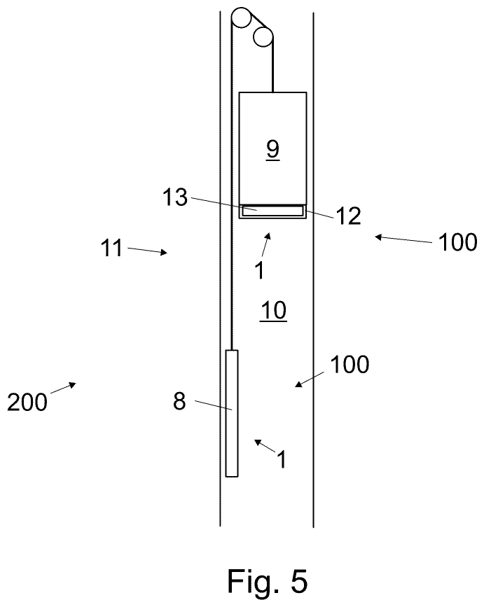

FIG. 5 is a schematic side view of an elevator comprising elevator elements shown in partial cross-section. It is to be noted that the embodiment is shown in a highly simplified manner.

In one embodiment, the elevator 200 comprises an elevator car 9 that defines an interior space for accommodating passengers and/or load. The elevator car 9 is arranged in an elevator shaft 10. The elevator 200 may further comprise a counterweight 8, and a roping 11 arranged to connect the elevator car 9 to the counterweight 8.

In one embodiment, the elevator element 100 described in this disclosure is the counterweight 8.

In one embodiment, the elevator element 100 described in this disclosure is arranged in the elevator car 9. Said elevator element may serve e.g. as a car ballast or balance weight 13.

In one embodiment, the balance weight 13 is arranged in a holder or rack 12 that is positioned e.g. underside of the elevator car 9.

In one embodiment, the elevator 200 comprises elevator elements 100 both in the counterweight and the elevator car.

In one embodiment, the elevator 200 comprises a compensation rope and a tension weight (not shown) arranged thereto. Said tension weight may comprise the elevator element 100 described in this disclosure.

In one embodiment, the elevator 200 comprises an overspeed governor rope and a tension weight (not shown) arranged thereto. Said tension weight may comprise the elevator element 100 described in this disclosure.

In one embodiment, the elevator 100 comprises a rescue rope and a tension weight (not shown) arranged thereto. Said tension weight may comprise the elevator element 100 described in this disclosure.

In one embodiment, the elevator 100 comprises a stalling detection rope and a tension weight (not shown) arranged thereto. Said tension weight may comprise the elevator element 100 described in this disclosure.

In one embodiment, the elevator 100 comprises a landing door closing weight and a tension weight (not shown) arranged thereto. Said tension weight may comprise the elevator element 100 described in this disclosure.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 body part
2 reinforcing element
3 frame structure
4a, b sub-part
5 section of the body part
6 recess
7 inward sub-part
8 counterweight
9 elevator car
10 elevator shaft
11 roping
12 holder
13 balance weight
100 elevator element
200 elevator

1. An elevator element, comprising
a body part made of CO₂-cured slag, and
a reinforcing element embedded in the body part, wherein
the reinforcing element is made of fibre-reinforced plastic (FRP).

2. The elevator element as claimed in claim 1, wherein
the reinforcing element comprises glass-fibres embedded in polymer matrix.

3. The elevator element as claimed in claim 1, wherein
the reinforcing element comprises basalt-fibres embedded in polymer matrix.

4. The elevator element as claimed in claim 1, wherein
the reinforcing element comprises a bar.

5. The elevator element as claimed in claim 4, wherein
the bar has a shape of rebar.

6. The elevator element as claimed in claim 1, wherein
the reinforcing element comprises a plate.

7. The elevator element as claimed in claim 1, wherein
the reinforcing element comprises a web.

8. The elevator element as claimed in claim 1, comprising
a frame structure arranged on the surface of the body part, and wherein
the reinforcing element is arranged to overlap with the frame structure.

9. The elevator element as claimed in claim 8, wherein
the frame structure comprises two sub-parts that extend on two opposite surfaces of the body part, and
the reinforcing element is arranged to extend in a section of the body part being situated between said two sub-parts.

10. The elevator element as claimed in claim 8, wherein
the surface of the body part comprises a recess,
the frame structure comprises an inward sub-part arranged on the surface of said recess, and
the reinforcing element is arranged to extend in a section of the body part being on situated laterally with said inward sub-part.

11. The elevator element as claimed in claim 1, wherein
the element is a counterweight.

12. The elevator element as claimed in claim 1, wherein
the element is a balance weight.

13. An elevator, comprising the elevator element claimed in claim 1.
